(19) United States
(12) Patent Application Publication
(10) Pub. No.: US 2025/0365547 A1
(43) Pub. Date: Nov. 27, 2025

(54) AUDIO SIGNAL PROCESSING METHOD, AUDIO PLAYBACK DEVICE, AND STORAGE MEDIUM

(71) Applicant: GUANGDONG OPPO MOBILE TELECOMMUNICATIONS CORP., LTD., Dongguan (CN)

(72) Inventor: Tianfu LIAN, Dongguan (CN)

(21) Appl. No.: 19/181,740

(22) Filed: Apr. 17, 2025

Related U.S. Application Data
(63) Continuation of application No. PCT/CN2023/118456, filed on Sep. 13, 2023.

(30) Foreign Application Priority Data
Nov. 3, 2022 (CN) 202211370718.0

(51) Int. Cl. H04S 7/00; G06F 3/16; H04R 1/10

(52) U.S. Cl. CPC H04S 7/301; G06F 3/165; H04R 1/1016

(57) ABSTRACT

Provided are an audio signal processing method, an audio playback device and a storage medium. The method is applied to the audio playback device. In the method, hearing feature information for first detection audio signals are acquired, the first detection audio signals being output by a terminal device that establishes a communication connection with the audio playback device. A transparent transmission parameter is determined based on the hearing feature information, the transparent transmission parameter being configured to perform transparent transmission processing on a target audio signal to be received.

### CROSS-REFERENCE OF RELATED APPLICATION

This application is a continuation of International Application No. PCT/CN2023/118456 filed Sep. 13, 2023, which claims priority to Chinese patent application No. 202211370718.0 filed Nov. 3, 2022. All contents of them are incorporated by reference herein.

### TECHNICAL FIELD

The present disclosure relates to the technical field of electronic devices, and in particular to an audio signal processing method, an audio playback device, and a storage medium.

BACKGROUND

Currently, when users wear and use audio playback devices (such as headphones, and hearing aids), due to differences in hearing-related characteristics such as ear canal structure among different users, different users often have very different experiences in using the audio playback devices. In practice, it is found that, when an audio playback device needs to perform transparent transmission (passthrough) processing on audio signals in the external environment, traditional audio processing methods (such as volume adjustment, and noise reduction) are usually unable to make effective adjustments for the above differences, resulting in difficulty for the audio playback device to perform appropriate transparent transmission processing on external audio signals.

### SUMMARY

Embodiments of the present disclosure disclose an audio signal processing method, an audio playback device, and a storage medium.

In a first aspect, the embodiments of the present disclosure disclose an audio signal processing method. The method is applied to an audio playback device including a feedforward microphone, and the method includes:
acquiring hearing feature information for first detection audio signals, where the first detection audio signals are output by a terminal device that establishes a communication connection with the audio playback device; and
determining a transparent transmission parameter based on the hearing feature information, where the transparent transmission parameter is configured to perform transparent transmission processing on a target audio signal received by the feedforward microphone.

In a second aspect, the embodiments of the present disclosure disclose an audio playback device including a memory and a processor. The memory stores therein a computer program which, when being executed by the processor, causes the processor to implement all or part of operations in the audio signal processing method disclosed in the first aspect of the embodiments of the present disclosure.

In a third aspect, the embodiments of the present disclosure disclose a computer-readable storage medium storing a computer program thereon. The computer program, when being executed by a processor, causes all or part of operations in the audio signal processing method disclosed in the first aspect of the embodiments of the present disclosure to be implemented.

### BRIEF DESCRIPTION OF THE DRAWINGS

In order to more clearly illustrate technical solutions in the embodiments of the present disclosure, drawings required in the embodiments will be briefly introduced below. Apparently, the drawings described below are only some embodiments of the present disclosure. For those of ordinary skill in the art, other drawings can be obtained based on these drawings without paying creative work.

FIG. 1A is a schematic diagram illustrating an application scenario of an audio signal processing method as disclosed in the embodiments of the present disclosure.

FIG. 1B is a schematic diagram illustrating another application scenario of the audio signal processing method as disclosed in the embodiments of the present disclosure.

FIG. 2 is a schematic diagram illustrating the structure of an audio playback device as disclosed in the embodiments of the present disclosure.

FIG. 3 is a flow chart of an audio signal processing method as disclosed in the embodiments of the present disclosure.

FIG. 4A is a schematic diagram illustrating a signal transmission link applied to the audio playback device as disclosed in the embodiments of the present disclosure.

FIG. 4B is a schematic diagram illustrating another signal transmission link applied to the audio playback device as disclosed in the embodiments of the present disclosure.

FIG. 4C is a schematic diagram illustrating a further signal transmission link applied to the audio playback device as disclosed in the embodiments of the present disclosure.

FIG. 4D is a schematic diagram illustrating a fourth signal transmission link applied to the audio playback device as disclosed in the embodiments of the present disclosure.

FIG. 5 is a flow chart of another audio signal processing method as disclosed in the embodiments of the present disclosure.

FIG. 6 is a schematic diagram illustrating a process of obtaining ear canal feature information as disclosed in the embodiments of the present disclosure.

FIG. 7 is a schematic diagram illustrating an amplitude-frequency response corresponding to an ear canal equalization transfer function as disclosed in the embodiments of the present disclosure.

FIG. 8 is a schematic diagram illustrating a process of obtaining hearing feature information as disclosed in the embodiments of the present disclosure.

FIG. 9 is a schematic diagram of fitting a corresponding hearing compensation transfer function from the hearing feature information as disclosed in the embodiments of the present disclosure.

FIG. 10 is a flow chart of a further audio signal processing method as disclosed in the embodiments of the present disclosure.

FIG. 11 is a schematic diagram illustrating an amplitude-frequency response corresponding to cascaded first filter and second filter as disclosed in the embodiments of the present disclosure.

FIG. 12 is a schematic diagram illustrating an effect of personalized hearing compensation processing and personalized ear canal equalization processing performed by the filters shown in FIG. 11.

FIG. 13 is a modular schematic diagram of an audio signal processing apparatus as disclosed in the embodiments of the present disclosure.

FIG. 14 is a modular schematic diagram of an audio playback device as disclosed in the embodiments of the present disclosure.

### DETAILED DESCRIPTION OF PREFERRED EMBODIMENTS

The technical solutions in the embodiments of the present disclosure will be described clearly and comprehensively below in conjunction with the drawings in the embodiments of the present disclosure. Apparently, the described embodiments are only part of the embodiments of the present disclosure, rather than all the embodiments. All other embodiments, obtained by those of ordinary skill in the art based on the embodiments in this disclosure without paying any creative work, shall fall within the scope of protection of this disclosure.

It is notable that terms “include/comprise” and “have” in the embodiments of the present disclosure and any variations thereof are intended to cover non-exclusive inclusions. For example, a process, method, system, product or device including a series of steps or units is not necessarily limited to those steps or units clearly listed, but may include other steps or units that are not clearly listed or inherent to such process, method, product or device.

The embodiments of the present disclosure disclose an audio signal processing method and apparatus, an audio playback device, and a storage medium, by which personalized transparent transmission compensation can be performed, according to differences in hearing characteristics of different users, on external audio signals received by the audio playback device, and the user can be provided with a suitable audio signal after undergoing the transparent transmission processing. This is beneficial to improving the accuracy of the transparent transmission processing performed on the external audio signals by the audio playback device.

Detailed description is given below with reference to the accompanying drawings.

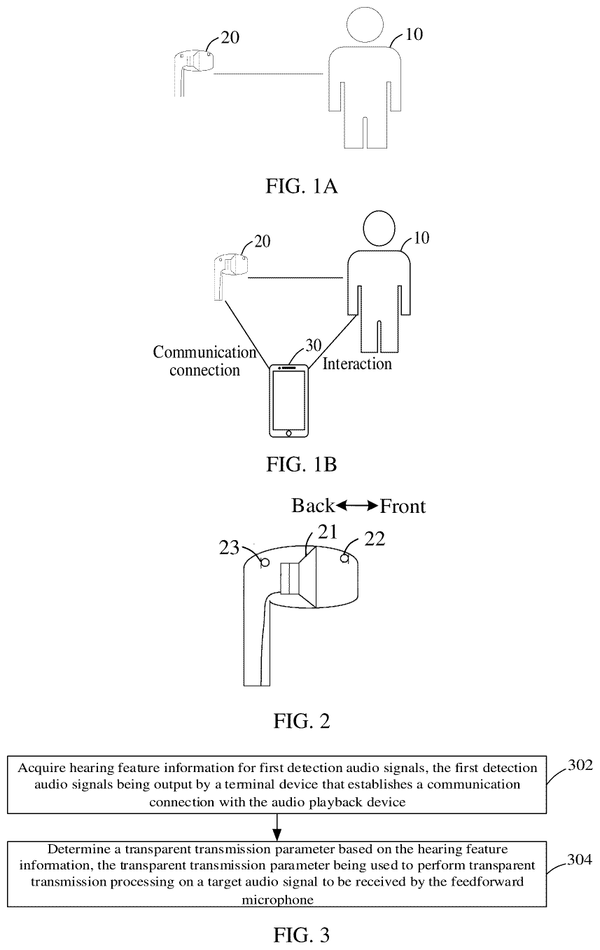

Referring to FIG. 1A and FIG. 1B together, FIG. 1A is a schematic diagram illustrating an application scenario of the audio signal processing method as disclosed in the embodiments of the present disclosure, and FIG. 1B is a schematic diagram illustrating another application scenario of the audio signal processing method as disclosed in the embodiments of the present disclosure. As illustrated in FIG. 1A, the application scenario may include a user 10 and an audio playback device 20. The user 10 may use the audio playback device 20 to detect the impact of the user's own hearing-related characteristics (such as personalized ear canal structure differences, and personalized hearing features) on his or her hearing effect. In particular, it may be used to detect different impacts that such hearing-related characteristics would have on the audio signals received by the user 10 when the audio playback device 20 needs to perform transparent transmission processing on the audio signals in the external environment. On this basis, a suitable filter(s) may be configured in the audio playback device 20, and the external audio signal received by the audio playback device 20 may be filtered accordingly to achieve personalized transparent transmission compensation, so that the audio signal received by the user 10 can be as close to the actual external audio signal as possible, thereby improving the user experience of the user 10 in using the transparent transmission function of the audio playback device 20.

As illustrated in FIG. 2, the audio playback device 20 may include a first speaker 21 and a feedback microphone 22 arranged in front of the first speaker 21 (i.e., when the user wears the audio playback device, the feedback microphone is located between the first speaker and the user's eardrum). The feedback microphone 22 may collect an audio signal output by the first speaker 21 and transmitted through the ear canal of the user 10, and collect an audio signal transmitted to the user 10 from the external environment “passing through” the audio playback device 20. In addition, the audio playback device 20 may also include a feedforward microphone 23 arranged behind the first speaker 21 (i.e., when the user wears the audio playback device, the feedforward microphone is located between the first speaker and the external environment). The feedforward microphone 23 collects audio signals in the external environment.

On this basis, the above-mentioned transparent transmission function means that the audio playback device 20 may output, through its first speaker 21, to the user 10 the external audio signal received by the feedforward microphone 23 after a certain transparent transmission compensation, so that the external audio signal can “pass through” the audio playback device 20 and be received by the eardrum of the user 10. This enables the user 10 to still accurately receive the audio signal in the external environment (such as ambient sound, and human voice) when wearing the audio playback device 20.

In the embodiments of the present disclosure, in order to realize the transparent transmission function for external audio signals, the audio playback device 20 may first detect personalized ear canal structure differences, personalized hearing features and other hearing-related characteristics of the user 10, and determine a corresponding transparent transmission parameter(s) based on the detection results, so as to configure a suitable transparent transmission compensation filter(s). In some embodiments, in order to implement such detections, in addition to outputting and receiving corresponding detection audio signals by the audio playback device 20, the user 10 may also perform necessary interactive operations with the audio playback device 20 (for example, interacting with the audio playback device through click, touch, etc.) to assist in acquiring the ear canal feature information, the hearing feature information and the like of the user 10.

In some implementations, as illustrated in FIG. 1B, the audio playback device 20 may also establish a communication connection with a terminal device 30. The terminal device 30 may transmit required detection audio data to the audio playback device 20 based on such communication connection, so that the audio playback device 20 outputs a corresponding detection audio signal through its first speaker 21. The terminal device may also directly output the required detection audio signals through its built-in second speaker (not shown in the figure) in a loudspeaker mode (i.e., the audio signals are played out load). In some embodiments, the user 10 may also interact with the terminal device 30 to trigger, through the terminal device 30, the audio playback device 20 to perform the above detections. Exemplarily, when the terminal device 30 detects a test interaction operation performed by the user 10 on it (for example, a touch operation such as a clicking or sliding operation performed on a test button on the terminal device 30, a voice operation containing a specified keyword such as “test” sent to the terminal device 30, and a movement operation such as an operation of moving the terminal device 30 along a preset trajectory), the terminal device 30 may send a corresponding test instruction to the audio playback device 20 to trigger the audio playback device 20 to output a corresponding detection audio signal. In some other embodiments, the user 10 may also perform other necessary interactive operations with the terminal device 30 (for example, interacting with the terminal device through click, touch, etc.) to assist in acquiring the ear canal feature information, hearing feature information and the like of the user 10.

Exemplarily, the audio playback device 20 may include various electronic devices with audio receiving and output functions, such as headphones and hearing aids, and may particularly include True Wireless Stereo (TWS) headphones. Exemplarily, the terminal device 30 may include various devices or systems that have communication functions and can establish a communication connection with the audio playback device 20, such as mobile phone, smart wearable device, vehicle-mounted terminal, tablet computer, Personal Computer (PC), and Personal Digital Assistant (PDA), which are not specifically limited in the embodiments of the present disclosure.

In the embodiments of the present disclosure, in order to determine the transparent transmission parameter, the audio playback device 20 may acquire hearing feature information for first detection audio signals, where the first detection audio signals may be output by the terminal device 30 that establishes a communication connection with the audio playback device 20. On this basis, the audio playback device 20 may determine a corresponding transparent transmission parameter based on the hearing feature information, and the transparent transmission parameter may be used to perform transparent transmission processing on a target audio signal to be received by the feedforward microphone 23.

As can be seen, with such an audio signal processing method, the audio playback device 20 can accurately determine corresponding transparent transmission parameters according to differences in the hearing features of different users 10, and perform personalized transparent transmission compensation on the external audio signals subsequently received by the audio playback device 20, so that the audio playback device 20 can transparently transmit the external audio signals to the user 10 as accurately as possible.

In some implementations, the audio playback device 20 may also acquire ear canal feature information calculated based on a first received audio signal, where the first received audio signal is a received audio signal corresponding to a second detection audio signal and collected by the feedback microphone 22, and the second detection audio signal may be output by the audio playback device 20 through its first speaker 21. On this basis, the audio playback device 20 may determine the corresponding transparent transmission parameter(s) based on both the ear canal feature information and the hearing feature information.

Such an audio signal processing method can effectively improve the accuracy of the transparent transmission processing performed by the audio playback device 20 on external audio signals, and provide different users 10 with external audio signals that have undergone adaptive transparent transmission processing and match the hearing-related characteristics of the users 10, which is beneficial to improving the users 10's experience of using the audio playback device.

Referring to FIG. 3, a flow chart of an audio signal processing method as disclosed in the embodiments of the present disclosure is shown. The method may be applied to the above-mentioned audio playback device, and the audio playback device may include a first speaker, a feedforward microphone, and a feedback microphone. As illustrated in FIG. 3, the audio signal processing method may include operations 302 and 304 as follows.

At 302, hearing feature information is acquired for first detection audio signals, where the first detection audio signals are output by a terminal device that establishes a communication connection with the audio playback device.

In the embodiments of the present disclosure, in a case where the user is using the audio playback device (for example, wearing headphones or hearing aids), when the transparent transmission function is enabled, all or part of the audio signals in the external environment can be transmitted to the user's eardrum as accurately as possible, so as to achieve an effect that the external audio signals are transmitted to the user “passing through” the audio playback device (that is, an effect as close as possible to a hearing effect obtained when the user is not wearing the audio playback device). In order to realize the transparent transmission function, the audio playback device may first detect the user's own personalized ear canal structure differences, personalized hearing features and other hearing-related characteristics, and obtain the corresponding ear canal feature information, hearing feature information and the like, so as to perform, in subsequent operations, corresponding transparent transmission compensation on the target audio signals to be received from the outside world.

The hearing feature information may represent the user's personalized hearing features, that is, it indicates that there are differences in sensitivities of different users to audio signals at different frequency bands or with different spectral changes, which differences cause differentiated hearing effects when a same audio signal is transmitted to different users.

In the embodiments of the present disclosure, in order to detect the personalized hearing features of the user so as to obtain the hearing feature information of the user, specified first detection audio signals may be output to the user. Exemplarily, the first detection audio signals may include pure tone signals each at a specific frequency, for example, a pure tone signal at a medium or low frequency point such as 500 Hz, 1000 Hz, or 2000 Hz, and a pure tone signal at a high frequency point such as 4000 Hz, 6000 Hz, or 8000 Hz. It is understandable that the above-mentioned different test frequency points each may cover a certain frequency range, so that a more comprehensive test on the user's hearing characteristics in different frequency bands (i.e., sensitivities to audio signals in different frequency bands) may be performed, which is also beneficial to reducing the number of tests and save the test time. It is notable that the hearing test process is carried out when the user is using the audio playback device. Therefore, the hearing test process can relatively accurately reflect the different sensitivities of the user to audio signals in different frequency bands or with different spectral changes in actual scenarios where the user is wearing headphones or hearing aids, thereby helping to improve the accuracy and reliability of the transparent transmission processing performed on external audio signals by the audio playback device used by the user.

The first detection audio signals may be output by a device in the external environment, for example, output by the terminal device that establishes a communication connection with the audio playback device, or output by another independent audio playback device. It is illustrated by taking a case where the first detection audio signals are output by the terminal device as an example, the terminal device may be provided with a second speaker. In some embodiments, the terminal device may output the first detection audio signals through its second speaker when being triggered by the audio playback device; and in some other embodiments, the terminal device may also output the first detection audio signals through its second speaker when being directly triggered by the user.

On this basis, the audio playback device may determine, through analysis, the hearing feature information for the first detection audio signals, based on the user's feedback on the first detection audio signals, such as a feedback about whether the user hears the first detection audio signal. As such, it may comprehensively determine the hearing feature information of the user at multiple test frequency points, so that the hearing feature information may be used subsequently to perform more accurate transparent transmission compensation on the target audio signals to be received by the audio playback device.

At 304, a transparent transmission parameter is determined based on the hearing feature information, where the transparent transmission parameter is used to perform transparent transmission processing on a target audio signal to be received by the feedforward microphone.

In the embodiments of the present disclosure, after determining the hearing feature information, the audio playback device may perform analysis and calculation based on the hearing feature information, to evaluate the impact on an audio signal in the external environment that would be produced during a process that the audio signal is transmitted to the user's eardrum when the user uses the audio playback device. Then, the corresponding transparent transmission parameter may be calculated for transparent transmission compensation of the subsequently received audio signals.

As an optional implementation, the audio playback device may further detect a personalized ear canal structure difference of the user to obtain ear canal feature information of the user. The ear canal feature information may represent the personalized ear canal structure differences of the user, that is, it indicates that there are differences in the ear canal structures of different users, which differences cause differentiated hearing effects when a same audio signal is transmitted to different users.

In order to detect the personalized ear canal structure differences, a designated second detection audio signal may be output to the user by the audio playback device. Exemplarily, the second detection audio signal may include a white noise signal, or may also include an audio data signal corresponding to audio data with actual information, such as a music file, a recording file, or a chat voice. The second detection audio signal can cover a large frequency range, especially the main frequency bands included in the human ear hearable range, so that the influence of the audio system in which the audio playback device is located (that is, a path through which the audio signal output by the audio playback device is transmitted between the audio playback device and the user, which may be understood as the user's “ear canal”) on the second detection audio signal may be detected. It is notable that, when the user uses the audio playback device, the feedback microphone may be located between the first speaker and the user, so that the above audio system may also be approximately replaced by a path for transmitting the audio signal between the first speaker and the feedback microphone.

In some implementations, the second detection audio signal may be obtained locally by the audio playback device, or may also be obtained from the outside of the audio playback device. In some embodiments, the detection audio signals may be pre-stored in a storage module of the audio playback device; as such, when the second detection audio signal needs to be obtained, the audio playback device may directly call the specified second detection audio signal and output it through its built-in first speaker. In some other embodiments, the storage module may also store detection audio data for generating the detection audio signal (for example, amplitude-frequency data, signal-to-noise ratio data and the like for determining the detection audio signal), so that the audio playback device may call the detection audio data, locally generate a specified second detection audio signal, and then output it through the first speaker. In some other embodiments, the detection audio signal may be stored on the terminal device that communicates with the audio playback device. When the second detection audio signal needs to be obtained, the terminal device may send a specified second detection audio signal to the audio playback device, and the second detection audio signal is then output by the audio playback device through its first speaker.

After outputting the second detection audio signal through its built-in first speaker, the audio playback device may further receive, through its feedback microphone, a first received audio signal corresponding to the second detection audio signal. On this basis, the audio playback device may perform analysis and calculation based on the first received audio signal to determine corresponding ear canal feature information. In some embodiments, the audio playback device may also perform analysis and calculation based on both the first received audio signal and the second detected audio signal, to obtain the corresponding ear canal feature information.

On this basis, the audio playback device may also perform analysis and calculation based on both the ear canal feature information and the hearing feature information, to determine the corresponding transparent transmission parameter(s) for transparent transmission compensation of the subsequently received audio signals.

In some embodiments, when the audio playback device needs to perform transparent transmission compensation on a target audio signal received, a corresponding filter (i.e., a personalized transparent transmission filter) may be configured according to the transparent transmission parameter(s). Then, based on the filter, corresponding transparent transmission processing may be performed on the target audio signal received by the audio playback device through its feedforward microphone, and the target audio signal after undergoing the transparent transmission processing is output through the first speaker. In this way, the possible impact on the target audio signal that would be produced during a process that the target audio signal is transmitted in the audio system where the audio playback device is located can be equalized, so that the hearing effect of the target audio signal heard by the user can be as close as possible to a hearing effect obtained when the user is not wearing the audio playback device.

In some implementations, the filter may be composed of one or more filters, and the filter may include a Finite Impulse Response (FIR) filter or an Infinite Impulse Response (IIR) filter, which is not specifically limited in the embodiments of the present disclosure.

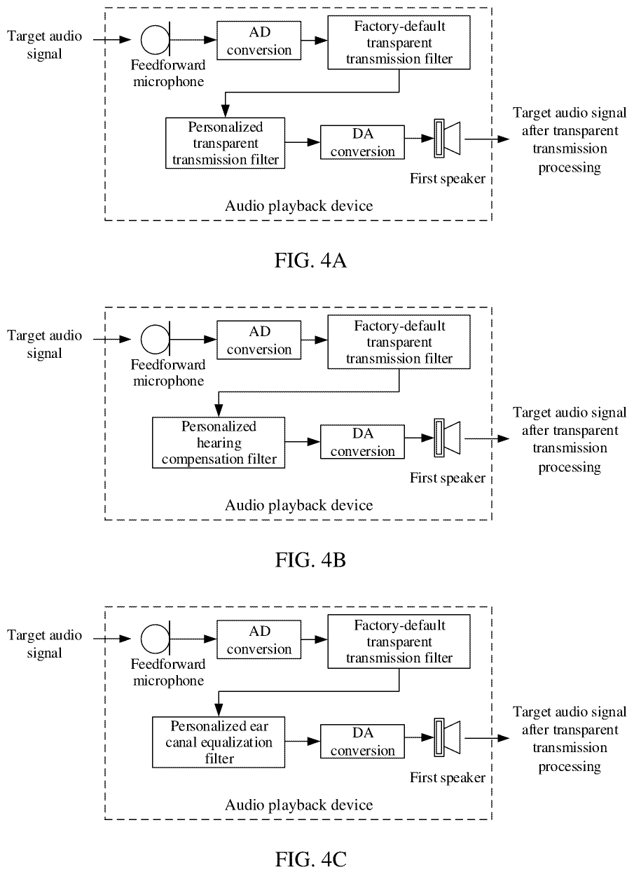

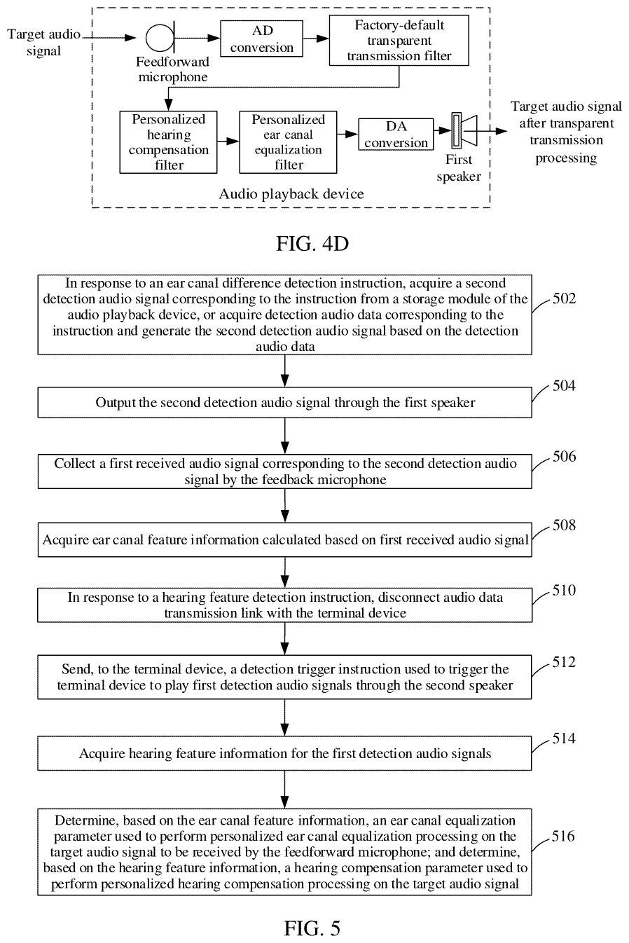

Exemplarily, referring to FIG. 4A, a schematic diagram illustrating a signal transmission link applied to the audio playback device as disclosed in the embodiments of the present disclosure is shown. As illustrated in FIG. 4A, after the audio playback device receives a target audio signal through its feedforward microphone, the target audio signal may first be processed by analog-to-digital conversion (ADC), a factory-default transparent transmission filter (obtained by configuring other necessary transparent transmission parameters that may be determined before the audio playback device leaves the factory), and then further subjected to corresponding transparent transmission compensation by a personalized transparent transmission filter. Thereafter, it may be further subjected to digital-to-analogue conversion (DAC) and output through the first speaker.

In some embodiments, as illustrated in FIG. 4B, the personalized transparent transmission filter may include a personalized hearing compensation filter. The personalized hearing compensation filter may be a filter that is configured, based on a hearing compensation parameter determined from the hearing feature information, to perform corresponding personalized hearing compensation on the target audio signal. That is, the transparent transmission processing may include only the process of personalized hearing compensation.

In some other embodiments, as illustrated in FIG. 4C, the personalized transparent transmission filter may also include a personalized ear canal equalization filter. The personalized ear canal equalization filter may be a filter that is configured, based on an ear canal equalization parameter determined from the ear canal feature information, to perform corresponding personalized ear canal equalization on the target audio signal. That is, the transparent transmission processing may include only the process of personalized ear canal equalization.

In some other embodiments, as illustrated in FIG. 4D, the personalized transparent transmission filter may include the personalized hearing compensation filter and the personalized ear canal equalization filter, that is, the transparent transmission processing may include a personalized ear canal equalization process and a personalized hearing compensation process. In some implementations, the audio playback device may perform transparent transmission compensation on the target audio signal through the personalized hearing compensation filter and the personalized ear canal equalization filter in sequence (as illustrated in FIG. 4D). Alternatively, it may be performed in an opposite order, that is, the transparent transmission compensation may be performed on the target audio signal through the personalized ear canal equalization filter and the personalized hearing compensation filter in sequence (not shown in the figure). This is not specifically limited in the embodiments of the present disclosure.

As can be seen, with the audio signal processing method described in the above embodiments, the audio playback device can accurately determine the corresponding transparent transmission parameters based on the differences in hearing characteristics of different users, and then perform personalized transparent transmission compensation for the external audio signals subsequently received by the audio playback device, so that the audio playback device can transparently transmit the external audio signals to the user as accurately as possible. Such an audio signal processing method can effectively improve the accuracy of the transparent transmission processing performed on the external audio signals by the audio playback device, and provide different users with external audio signals that have undergone adaptive transparent transmission processing and match the user's hearing-related characteristics, which is beneficial to improving the user's experience of using the audio playback device.

As illustrated in FIG. 5, a flow chart of another audio signal processing method as disclosed in the embodiments of the present disclosure is shown. The method may be applied to the above-mentioned audio playback device, and the audio playback device may include a first speaker, a feedforward microphone, and a feedback microphone. The audio playback device may also establish a communication connection with a terminal device, and the terminal device may include a second speaker. As illustrated in FIG. 5, the audio signal processing method may include operations 502-516 as follows.

At 502, in response to an ear canal difference detection instruction, a second detection audio signal corresponding to the ear canal difference detection instruction is acquired from a storage module of the audio playback device, or detection audio data corresponding to the ear canal difference detection instruction is acquired and the second detection audio signal is generated based on the detection audio data.

In the embodiments of the present disclosure, the second detection audio signal for detection of the difference in the user's personalized ear canal structure may be generated in real time when the audio playback device needs to perform the detection, or may also be generated in advance and stored in the storage module of the audio playback device. Exemplarily, for the situation where the second detection audio signal is generated in real time, in response to the ear canal difference detection instruction, the audio playback device may acquire, from the storage module, the detection audio data corresponding to the ear canal difference detection instruction (for example, amplitude-frequency data, signal-to-noise ratio data, and the like used to determine a detection audio signal), and generate a corresponding second detection audio signal based on the detection audio data. For the situation where the second detection audio signal is pre-stored, in response to the ear canal difference detection instruction, the audio playback device may directly call, from its storage module, the second detection audio signal corresponding to the ear canal difference detection instruction.

The storage module may include various storage components built into the audio playback device, such as built-in read-only memory (ROM), programmable read-only memory (PROM), and electronically-erasable programmable read-only memory (EEPROM), which are not specifically limited in the embodiments of the present disclosure.

In an embodiment, the ear canal difference detection instruction may be triggered by the user. In some embodiments, the ear canal difference detection instruction for the audio playback device may be triggered by the user operating the audio playback device (for example, a touch operation, a voice operation, or a movement operation for the audio playback device). In some other embodiments, the user may operate a terminal device that communicates with the audio playback device (for example, a touch operation, or a voice operation for the terminal device) to send the ear canal difference detection instruction to the audio playback device, so as to trigger the audio playback device to detect the difference in the personalized ear canal structure.

At 504, the second detection audio signal is output through the first speaker.

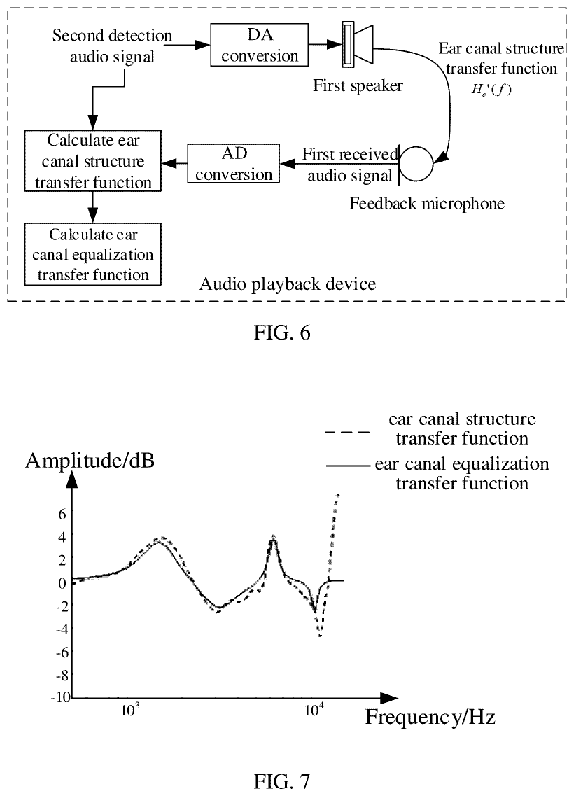

After acquiring the second detection audio signal, the audio playback device may output the second detection audio signal through its built-in first speaker. Exemplarily, referring to FIG. 6, a schematic diagram illustrating a process of obtaining ear canal feature information as disclosed in the embodiments of the present disclosure is shown. As illustrated in FIG. 6, the audio playback device may perform digital-to-analog conversion on the acquired second detection audio signal and output it through the first speaker. In a subsequent operation, the audio playback device may receive, through its feedback microphone, a first received audio signal corresponding to the second detection audio signal.

The second detection audio signal is transmitted in the user's ear canal (which is approximately replaced by a path through which the audio signal is transmitted between the first speaker and the feedback microphone). The impact produced in this process may be represented by an ear canal structure transfer function Hₑ′(f). That is, the second detection audio signal (where X represents its frequency domain) and the first received audio signal (where Y represents its frequency domain) may satisfy a relationship Hₑ′(f)=Y/X.

On this basis, as illustrated in FIG. 6, after performing analog-to-digital conversion on the first received audio signal, the audio playback device may calculate the corresponding ear canal structure transfer function Hₑ′(f) in combination with the second detection audio signal. Furthermore, in a subsequent operation, the audio playback device may also calculate, according to the ear canal structure transfer function Hₑ′(f), a corresponding ear canal equalization transfer function H_{eq}(f) as a transparent transmission parameter (i.e., an ear canal equalization parameter) for performing transparent transmission compensation on the user's personalized ear canal structure difference.

At 506, a first received audio signal corresponding to the second detection audio signal is collected by the feedback microphone.

In the embodiments of the present disclosure, after outputting the second detection audio signal, the audio playback device may immediately collect, through its built-in feedback microphone, the first received audio signal corresponding to the second detection audio signal.

Exemplarily, the feedback microphone of the audio playback device may continuously collect audio signals; and based on the timestamp at which the first speaker outputs the second detection audio signal, the first received audio signal collected by the feedback microphone at a time near this timestamp (such as delayed by 0.01 milliseconds, or delayed by 0.1 milliseconds) may be obtained. In some embodiments, the feedback microphone of the audio playback device may not be turned on continuously, but may be triggered to be turned on by the first speaker after the first speaker outputs the second detection audio signal, and the audio signal collected by the feedback microphone after being turned on may be used as the first received audio signal corresponding to the second detection audio signal.

In some implementations, for a received audio signal collected by the feedback microphone, the audio playback device may also use its built-in processing module to compare the waveform of the second detection audio signal output by the first speaker with the waveform of the received audio signal. When the comparison result indicates that the waveform similarity between the second detection audio signal and the received audio signal meets a similarity threshold (such as 50%, or 80%), the received audio signal may be confirmed as the first received audio signal corresponding to the second detection audio signal.

At 508, ear canal feature information calculated based on the first received audio signal is acquired.

The ear canal feature information may include the ear canal structure transfer function Hₑ′(f) of the user. The ear canal structure transfer function Hₑ′(f) may be used to calculate the corresponding ear canal equalization transfer function H_{eq}(f) in subsequent operations, so as to achieve transparent transmission compensation on the personalized ear canal structure difference of the user.

In the embodiments of the present disclosure, in order to calculate the ear canal structure transfer function Hₑ′(f), the audio playback device may perform windowed segmentation on the first received audio signal according to a unit window length, to obtain at least one frame of received audio sub-signal. Then, based on each frame of received audio sub-signal, the ear canal structure transfer function Hₑ′(f) corresponding to the first received audio signal is determined, which reduces the calculation difficulty and amount of calculation for determining the ear canal structure transfer function Hₑ′(f).

Exemplarily, when the audio playback device derives, based on the first received audio signal, the corresponding ear canal structure transfer function Hₑ′(f), it may first perform Fourier transform on the first received audio signal, and then perform subsequent calculations on the first received audio signal after undergoing the Fourier transform. Specifically, the built-in processing module of the audio playback device (such as a digital signal processing DSP module) may first perform frame division and windowing processing on the first received audio signal, that is, it divides the macroscopically unstable audio signal into multiple audio signal frames each having short-term stability (such as audio signal frames with a frame length of 10 milliseconds to 30 milliseconds); then, it may perform windowing and truncation processing on the multiple audio signal frames according to a specified window function, to obtain each frame of received audio sub-signal. Exemplarily, the windowing and truncation processing may be implemented by a window function as illustrated in Formula 1.

$$w ( n ) = 1 , 0 \leq n \leq N - 1 ; \qquad Formula 1$$

$$w ( n ) = 0 , others .$$

The piecewise function w(n) is the window function, and N is the unit window length. By performing time domain convolution on the first received audio signal and the window function, the effect of windowing and truncation may be achieved.

Furthermore, a certain frame of received audio sub-signal obtained after the frame division and windowing processing may be subjected to short-time Fourier transform through an algorithm such as Fast Fourier Transform (FFT), and the expression thereof may be shown in the following formula 2.

$${X}_{n} ( {e}^{j ω} ) = {\sum }_{m = - ∞}^{+ ∞} x ( m ) w ( n - m ) {e}^{- j ω m} \qquad Formula 2$$

where n represents discrete time, continuous frequency is ω=2πk/N, k=0, 1, . . . , N−1, where N is the Fourier transform length, and x(m) represents the m-th frame of received audio sub-signal.

On this basis, the transformed sequence may be represented by X(f, m), and the corresponding ear canal structure transfer function Hₑ′(f, m) may be indicated by the following formula 3.

$${{H}_{e}}^{′} ( f , m ) = ( 1 - μ ) * {{H}_{e}}^{′} ( f , m - 1 ) + μ * X ( f , m ) \qquad Formula 3$$

where f represents a frequency domain subband sequence, m represents a time sequence, and μ represents an iteration factor (i.e., a weight factor of the subband spectrum of the current frame).

In subsequent operations, the audio playback device may further determine the corresponding ear canal equalization transfer function H_{eq}(f) according to the ear canal structure transfer function Hₑ′(f) and a set reference transfer function Hₑ(f), and the calculation thereof may be as illustrated in the following formula 4.

$${H}_{eq} ( f ) = \frac{{H}_{e} ( f )}{{{H}_{e}}^{′} ( f ) + θ} \qquad Formula 4$$

where f represents a divided frequency domain subband, and θ represents a correction factor.

In some embodiments, since the differences in personalized ear canal structures of different users mainly affect the transmission process of audio signals in a higher frequency range (such as 1000 Hz or above), by analyzing the spectral changes in this higher frequency range, more significant personalized ear canal equalization can be achieved in subsequent operations, which is beneficial to improving the effectiveness of the transparent transmission compensation performed on the target audio signal to be received by the audio playback device.

Exemplarily, referring to FIG. 7, a schematic diagram illustrating an amplitude-frequency response corresponding to the ear canal equalization transfer function as disclosed in the embodiments of the present disclosure is shown. As illustrated in FIG. 7, the dotted line may represent an amplitude-frequency response of the ear canal structure transfer function Hₑ′(f), and the solid line may represent the amplitude-frequency response of the corresponding ear canal equalization transfer function H_{eq}(f). The equalization for lower frequency bands (such as frequency bands below 1000 Hz) is relatively unobvious, and the equalization for higher frequency bands is relatively obvious, which helps to achieve the personalized ear canal equalization processing.

At 510, in response to a hearing feature detection instruction, an audio data transmission link with the terminal device is disconnected.

In the embodiments of the present disclosure, the first detection audio signals for detection of the personalized hearing features of the user may be output by the terminal device that establishes a communication connection with the audio playback device. In some embodiments, the audio playback device may establish, with the terminal device, a Bluetooth communication connection, in particular a Bluetooth audio connection based on Advanced Audio Distribution Profile (A2DP). In order to enable the terminal device to output the first detection audio signals in a loudspeaker mode, the audio playback device may disconnect the audio data transmission link with the terminal device (and at the same time, retain or establish other data transmission links for transmitting instruction information), to ensure that the terminal device may perform the subsequent hearing detection.

Exemplarily, in response to the hearing feature detection instruction, the audio playback device may execute a corresponding process of disconnecting the audio data transmission link between the audio playback device and the terminal device. In an embodiment, the hearing feature detection instruction may be triggered by the user. In some embodiments, the hearing feature detection instruction for the audio playback device may be triggered by the user operating the audio playback device (for example, a touch operation, a voice operation, or a movement operation for the audio playback device). In some other embodiments, the user may operate the terminal device (for example, a touch operation, or a voice operation for the terminal device) to send the hearing feature detection instruction to the audio playback device, so as to trigger the audio playback device to disconnect the audio data transmission link between the audio playback device and the terminal device.

At 512, a detection trigger instruction is sent to the terminal device, where the detection trigger instruction is used to trigger the terminal device to play the first detection audio signals through the second speaker.

In the embodiments of the present disclosure, after the audio data transmission link between the terminal device and the audio playback device is disconnected, the terminal device may further receive the detection trigger instruction sent by the audio playback device. Under the triggering of the detection trigger instruction, the terminal device plays the specified first detection audio signals through its built-in second speaker. In some implementations, the terminal device may also take the event of disconnecting the audio data transmission link as the detection trigger instruction, and directly play the first detection audio signals in response to the detection trigger instruction.

The first detection audio signals output by the terminal device may be pure tone signals, that is, each first detection audio signal is composed of only audio signal components at a certain test frequency point (such as 500 Hz, or 1000 Hz) and does not contain audio signal components at other frequencies.

In some embodiments, in order to improve the accuracy of the hearing test, loudness calibration may be performed on the first detection audio signals before being output by the terminal device, to ensure that the subsequent hearing test process may be performed under a suitable benchmark. The minimum sound pressure level that can be heard by a large number of users at a certain test frequency point may be set as a reference volume 0 dB HL (dB HL is a unit of sound loudness). Before sending the detection trigger instruction to the terminal device, the audio playback device may first send a specified loudness calibration trigger instruction to trigger the terminal device to output, through its second speaker, a corresponding loudness calibration test signal.

Exemplarily, the audio playback device may collect, through its feedforward microphone, the loudness calibration test signal played by the terminal device, and then determine corresponding loudness calibration parameters based on the loudness calibration test signal. In the process of sending the detection trigger instruction to the terminal device, the loudness calibration parameters may be carried in the detection trigger instruction, to trigger the terminal device to perform, according to the loudness calibration parameters, loudness compensation calibration on the first detection audio signals before being played. On this basis, the terminal device may play, through its second speaker, the first detection audio signals after undergoing the loudness compensation calibration.

For example, after receiving the loudness calibration test signal, the audio playback device may separate, from the loudness calibration test signal, test sub-signals respectively at N (N is a positive integer greater than or equal to 1) test frequency points (such as 500 Hz, and 1000 Hz). It is understandable that each of the test sub-signals may also be a pure tone signal. Furthermore, the audio playback device may determine the loudness calibration parameter corresponding to each of the N test frequency points, according to a signal strength of the test sub-signal and a preset respective reference strength.

On this basis, the audio playback device may package the N loudness calibration parameters and send them separately to the terminal device, or directly send to the terminal device a detection trigger instruction containing the loudness calibration parameters respectively corresponding to the N test frequency points, so as to trigger the terminal device to perform, according to the loudness calibration parameters respectively corresponding to the N test frequency points, loudness compensation calibration on the first detection audio signals respectively at the N test frequency points before being played, and play, through the second speaker, the first detection audio signals respectively at the test frequency points after undergoing the loudness compensation calibration.

At 514, hearing feature information is acquired for the first detection audio signals.

Operation 514 is similar to the above operation 302. It is notable that, for the acquisition of the hearing feature information fed back by the user for the first detection audio signals, it may be achieved by the audio playback device through interaction with the user. That is, based on a feedback on whether the user hears a first detection audio signal, the hearing feature information corresponding to the first detection audio signal is determined. The hearing feature information may include subjective judgment information of whether the user hears the first detection audio signals, and may also include critical a sound loudness which is further determined from the subjective judgment information (that is, a sound loudness of each first detection audio signal at which the user can just hear the first detection audio signal), an audible sound loudness range, etc.

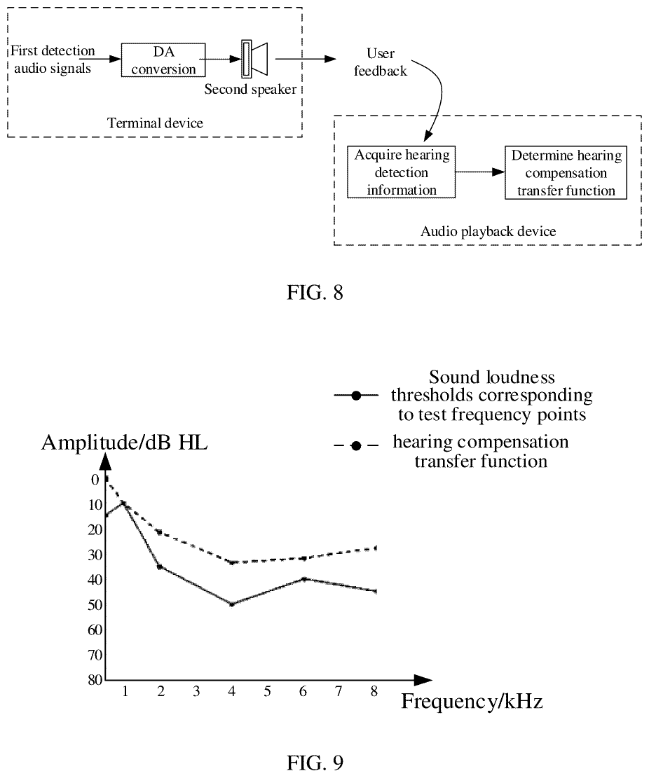

Exemplarily, referring to FIG. 8, a schematic diagram illustrating a process of obtaining the hearing feature information as disclosed in the embodiments of the present disclosure is shown. As illustrated in FIG. 8, the terminal device may perform digital-to-analog conversion on a first detection audio signal generated or stored therein, and output it through the second speaker. On this basis, based on a feedback on whether the user hears the first detection audio signal (for example, the user provides the feedback by operating the audio playback device or operating the terminal device), the audio playback device may obtain corresponding hearing feature information. In subsequent operations, the audio playback device may further determine, according to the hearing feature information, a corresponding hearing compensation transfer function Hₕ(f) as a transparent transmission parameter (i.e., a hearing compensation parameter) for transparent transmission compensation on the personalized hearing features of the user.

In an embodiment, when the feedback hearing feature information is acquired from the user through only the audio playback device, it may be acquired by detecting a user operation performed on the audio playback device. Exemplarily, the user operation performed on the audio playback device may include a touch operation, a voice operation, a movement operation, etc.

For example, when the user hears a first detection audio signal at a certain test frequency point, he/she may touch a designated touch point on the audio playback device. As such, when the audio playback device detects a touch operation performed on the designated touch point, it may determine a hearing state in which the user has heard the first detection audio signal, and then obtain the corresponding hearing feature information.

For another example, when the user hears the first detection audio signal, he/she may directly issue a voice command of “heard”; and when the user does not hear the first detection audio signal, he/she may directly issue a voice command of “not heard”. As such, the audio playback device may parse the detected voice command to determine whether the user has heard the first detection audio signal.

For another example, the user may move, rotate or shake the head in different directions depending on whether a first detection audio signal is heard, and the audio playback device may detect its own motion state through a sensor to determine a corresponding hearing state of whether the user hears the first detection audio signal. For example, when the user hears the first detection audio signal, he/she may tilt his/her head to the left so that the audio playback device detects a trend of moving to the left; and when the user does not hear the first detection audio signal, he/she may tilt his/her head to the right so that the audio playback device detects a trend of moving to the right. As such, the audio playback device may determine, based on the detected movement trend, the hearing feature information fed back by the user for the first detection audio signal. For another example, when the user hears the first detection audio signal, he/she may turn his/her head horizontally to the left (or horizontally to the right); when the user does not hear the first detection audio signal, he/she may turn his/her head horizontally to the right (or horizontally to the left). As such, the audio playback device may determine, based on the detected motion trajectory, the hearing feature information fed back by the user for the first detection audio signal. For yet another example, when the user hears the first detection audio signal, he/she may shake his/her head back and forth (i.e. nod); when the user does not hear the first detection audio signal, he/she may shake his/her head left and right (i.e. shake the head). As such, the audio playback device may also determine, based on the detected movement direction or frequency, the hearing feature information fed back by the user for the first detection audio signal.

In another embodiment, when the feedback hearing feature information is also acquired from the user through a terminal device commutating with the audio playback device, it may also be acquired by obtaining a user operation performed on the terminal device. Exemplarily, the user operation performed on the terminal device may include a touch operation, a button click operation, and the like. When the terminal device detects the user operation, it may determine, based on the user operation, the hearing state of whether the user hears the first detection audio signal, and send the hearing state to the audio playback device. On this basis, the audio playback device may further obtain, according to the received hearing state, the hearing feature information fed back for the first detection audio signal.

As a specific example, for a first detection audio signal at/corresponding to a first test frequency point (i.e., any one of the above-mentioned N test frequency points), the audio playback device may acquire a hearing state fed back for this first detection audio signal, and adjust, according to the hearing state, a first sound loudness of this first detection audio signal output by the terminal device, so as to finally determine a sound loudness threshold corresponding to the first test frequency point. The sound loudness threshold indicates a critical sound loudness at which the first detection audio signal at the first test frequency point can be heard by the user when the user uses the audio playback device. On this basis, the audio playback device may use the sound loudness threshold as the hearing feature information fed back for this first detection audio signal at the first test frequency point.

Exemplarily, if the hearing state indicates that the first sound loudness of the first detection audio signal does not meet a critical condition, the sound loudness of the first detection audio signal may be adjusted at the terminal device, then the adjusted first detection audio signal is output through the second speaker of the terminal device, and the operation of obtaining the hearing state fed back by the user is performed again, until the obtained first sound loudness of the first detection audio signal meets the critical condition. On this basis, the audio playback device may determine the first sound loudness (i.e., the sound loudness threshold) of the first detection audio signal that meets the critical condition as the hearing feature information corresponding to the first test frequency point. The critical condition may indicate a situation where the user can just hear the first detection audio signal. The sound loudness thresholds corresponding to other test frequency points may be obtained similarly to the sound loudness threshold corresponding to the first test frequency point.

It is notable that the audio playback device may first execute operations 502 to 508 and then execute operations 510 to 514 to sequentially obtain the ear canal feature information and the hearing feature information of the user. Alternatively, the hearing feature information and the ear canal feature information of the user may be acquired in sequence by first executing operations 510 to 514 and then executing operations 502 to 508. This is not specifically limited in the embodiments of the present disclosure.

At 516, an ear canal equalization parameter is determined based on the ear canal feature information, where the ear canal equalization parameter is used to perform personalized ear canal equalization processing on the target audio signal to be received by the feedforward microphone; and a hearing compensation parameter is determined based on the hearing feature information, where the hearing compensation parameter is used to perform personalized hearing compensation processing on the target audio signal.

In the embodiments of the present disclosure, the transparent transmission parameter may include the ear canal equalization parameter and the hearing compensation parameter. The ear canal equalization parameter may be used to configure the corresponding personalized ear canal equalization filter (see FIG. 4C to FIG. 4D) so as to perform personalized ear canal equalization processing on the audio signal received by the feedforward microphone from the external environment. The hearing compensation parameter may be used to configure the corresponding personalized hearing compensation filter (see FIG. 4B and FIG. 4D) so as to perform personalized hearing compensation processing on the audio signal received by the feedforward microphone from the external environment.

Exemplarily, the ear canal equalization parameter may include the ear canal equalization transfer function H_{eq}(f). The process of determining the ear canal equalization parameter based on the ear canal feature information may be specifically referred to the relevant descriptions of operations 504 to 508 and FIG. 6 and FIG. 7, which will not be repeated here.

Exemplarily, the hearing compensation parameter may include a hearing compensation transfer function Hₕ(f). Referring to FIG. 9, a schematic diagram of fitting a corresponding hearing compensation transfer function from the hearing feature information as disclosed in the embodiments of the present disclosure is shown. As illustrated in FIG. 9, the points connected by the dotted line may represent the sound loudness thresholds corresponding to various test frequency points in the hearing feature information, and the solid line may represent the amplitude-frequency response curve corresponding to the hearing compensation transfer function Hₕ(f) obtained by fitting the above-mentioned points.

For example, if the hearing feature information is expressed as:

$$Hr = [ {h}_{1} , {h}_{2} , {h}_{3} , {h}_{4} , {h}_{5} , {h}_{6} , … ] \qquad Formula 5$$

where hₙ represents the sound loudness threshold corresponding to an n-th test frequency point. After fitting and smoothing, the corresponding hearing compensation transfer function Hₕ(f) may be indicated by the following formula 6:

$${H}_{h} ( f ) = [ {hs}_{1} , ( {hs}_{1} + {hs}_{2} + {hs}_{3} ) / 3 , \\ ( {hs}_{1} + {hs}_{2} + {hs}_{3} + {hs}_{4} + {hs}_{5} ) / 5 , ( {hs}_{2} + {hs}_{3} + {hs}_{4} + {hs}_{5} + {hs}_{6} ) / 5 , … ]$$

where hsₙ=βₙ*(hₙ+Cfₙ), βₙ represents a hearing weight correction factor corresponding to hₙ, and Cfₙ represents a sound loudness calibration factor corresponding to hₙ. By fitting the individual points of Hₕ(f), the amplitude-frequency response curve corresponding to the corresponding hearing compensation transfer function may be obtained.

As an optional implementation, when the audio playback device acquires the hearing feature information for the first detection audio signals, it may utilize the audio playback device after undergoing the personalized ear canal equalization (for which the signal transmission link shown in FIG. 4C is applied) to perform subsequent hearing feature detection, or it may simultaneously perform personalized ear canal equalization and personalized hearing compensation after the hearing feature detection is completed, which is not specifically limited in the embodiments of the present disclosure.

As can be seen, with the audio signal processing method described in the above embodiments, the audio playback device can accurately determine the corresponding transparent transmission parameters based on the ear canal structure differences and the hearing feature differences of different users, and then perform personalized transparent transmission compensation for the external audio signals subsequently received by the audio playback device, so that the audio playback device can transparently transmit the external audio signals to the user as accurately as possible. This can effectively improve the accuracy of the transparent transmission processing performed on the external audio signals by the audio playback device, and it is conducive to improving the user experience of using the audio playback device. In addition, the ear canal difference detection and the hearing feature detection performed based on the audio playback device and the terminal device enable the detection process of the user's hearing-related characteristics to be implemented conveniently and reliably without the need for a special detection device. This effectively reduces the difficulty of configuring personalized transparent transmission filters using the audio playback device, and improves the convenience of the audio playback device in performing transparent transmission processing on external audio signals.

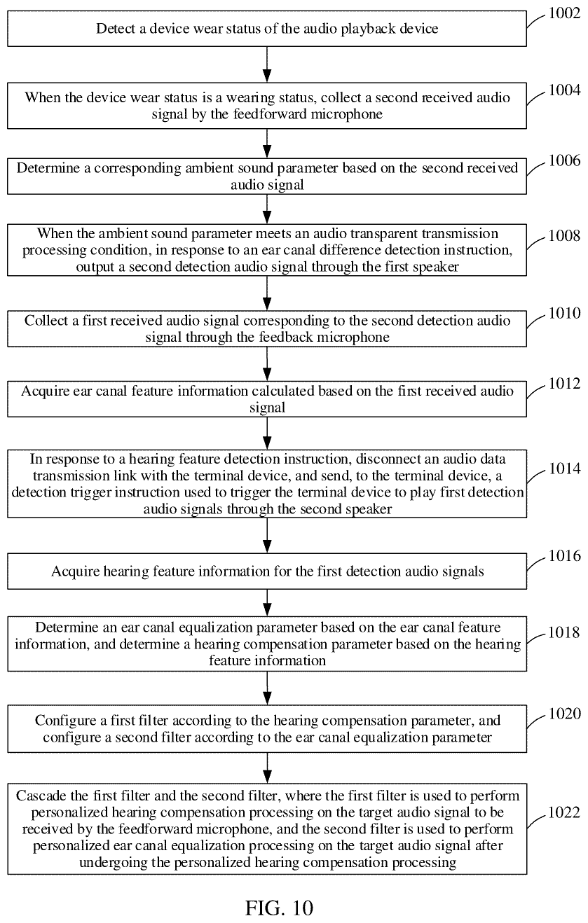

Referring to FIG. 10, a flow chart of a further audio signal processing method as disclosed in the embodiments of the present disclosure is shown. The method may be applied to the above-mentioned audio playback device, and the audio playback device may include a first speaker, a feedforward microphone, and a feedback microphone. The audio playback device may also establish a communication connection with a terminal device, and the terminal device may include a second speaker. As illustrated in FIG. 10, the audio signal processing method may include operations 1002 to 1022 as follows.

At 1002, a device wear status of the audio playback device is detected.

In the embodiments of the present disclosure, the audio playback device may perform the various detections in the above embodiments only when the audio playback device is normally worn by the user. Exemplarily, the audio playback device may first detect the device wear status of itself, and when the device wear status is a wearing status in which the audio playback device is being worn by the user, the audio playback device performs the ear canal difference detection and the hearing feature detection in subsequent operations.

At 1004, when the device wear status is the wearing status, a second received audio signal is collected through the feedforward microphone.

At 1006, a corresponding ambient sound parameter is determined based on the second received audio signal.

In the embodiments of the present disclosure, before the audio playback device outputs the second detection audio signal through its first speaker, the audio playback device may first collect an ambient sound in the external environment through its feedforward microphone, and then determine, based on the collected ambient sound, whether the current environment of the audio playback device is suitable for subsequent ear canal difference detection and hearing feature detection.

Exemplarily, in a case where the user is wearing the audio playback device, the audio playback device may collect the second received audio signal through the feedforward microphone, and then calculate, through analysis, the corresponding ambient sound parameter (such as noise frequency, and noise energy) based on the second received audio signal. In some embodiments, the audio playback device may first filter the second received audio signal through a preset bandpass filter or a low-pass filter to obtain a corresponding low-frequency ambient sound signal. The preset bandpass filter or low-pass filter may be used to specifically obtain a low-frequency ambient sound signal in the second received audio signal that may interfere with the ear canal difference detection or hearing feature detection. Furthermore, the audio playback device may also calculate the noise energy of the low-frequency ambient sound signal. When the noise energy is lower than a noise energy threshold (which may be set to 0, indicating that a test environment with no interference noise is required), the subsequent operation of outputting a second detection audio signal through the first speaker in response to an ear canal difference detection instruction is performed.

At 1008, when the ambient sound parameter meets an audio transparent transmission processing condition, in response to an ear canal difference detection instruction, a second detection audio signal is output through the first speaker.

Operation 1008 is similar to the above operation 502. In the embodiments of the present disclosure, if the ambient sound parameter meets the pre-set audio transparent transmission processing condition (for example, the noise energy is lower than the specified noise energy threshold or within a specified noise energy threshold range), in response to the ear canal difference detection instruction, the audio playback device may acquire the second detection audio signal corresponding to the ear canal difference detection instruction from its storage module, or acquire detection audio data corresponding to the ear canal difference detection instruction and generate the second detection audio signal based on the detection audio data, and then output the second detection audio signal through its first speaker.

At 1010, a first received audio signal corresponding to the second detection audio signal is collected through the feedback microphone.

At 1012, ear canal feature information calculated based on the first received audio signal is acquired.

Operations 1010 and 1012 are similar to the above-mentioned operations 506 and 508, which are not repeated here.

At 1014, in response to a hearing feature detection instruction, an audio data transmission link with the terminal device is disconnected, and a detection trigger instruction is sent to the terminal device, where the detection trigger instruction is used to trigger the terminal device to play first detection audio signals through the second speaker.

Operation 1014 is similar to the above-mentioned operations 510 and 512, which will not be repeated here.

At 1016, hearing feature information for the first detection audio signals is acquired.

At 1018, an ear canal equalization parameter is determined based on the ear canal feature information, and a hearing compensation parameter is determined based on the hearing feature information.

Operations 1016 and 1018 are similar to the above-mentioned operations 514 and 516, which will not be repeated here.

At 1020, a first filter is configured according to the hearing compensation parameter, and a second filter is configured according to the ear canal equalization parameter.

At 1022, the first filter and the second filter are cascaded, where the first filter is used to perform personalized hearing compensation processing on the target audio signal to be received by the feedforward microphone, and the second filter is used to perform personalized ear canal equalization processing on the target audio signal after undergoing the personalized hearing compensation processing.

In the embodiments of the present disclosure, the first filter may include the personalized hearing compensation filter configured to perform personalized hearing compensation processing on the audio signal received by the feedforward microphone from the external environment. The second filter may include the personalized ear canal equalization filter configured to perform personalized ear canal equalization processing on the audio signal.

It is notable that, after the first filter and the second filter are cascaded, the audio playback device may sequentially perform the personalized hearing compensation processing and the personalized ear canal equalization processing on the target audio signal to be received by the feedforward microphone. Exemplarily, as illustrated in the signal transmission link shown in FIG. 4C, after the audio playback device receives the target audio signal through its feedforward microphone, the target audio signal may first undergo common processing such as analog-to-digital conversion and factory-fault transparent transmission filtering, and then further undergo corresponding personalized transparent transmission compensation by the first filter and the second filter, and then undergo digital-to-analog conversion for output by the first speaker.

In some embodiments, when configuring the corresponding first filter and second filter based on the hearing compensation parameter and the ear canal equalization parameter, the audio playback device may determine the corresponding filter configuration parameter according to the required filter type. Exemplarily, taking a case where the first filter is configured according to the hearing compensation parameter as an example, the audio playback device may determine, according to the corresponding hearing compensation transfer function Hₕ(f), the center frequency f₀, the gain coefficient Gain and the quality factor Q of the first filter, so that the corresponding first filter may be configured according to such filter configuration parameters, to perform personalized hearing compensation processing on the target audio signal to be received.

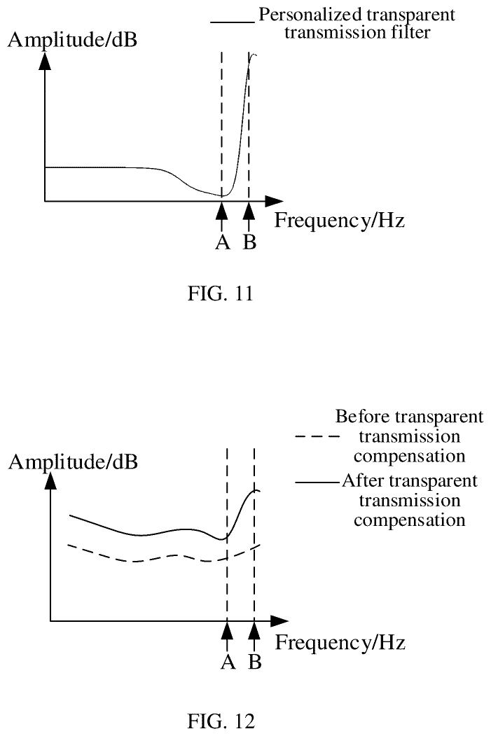

For example, referring to FIG. 11 and FIG. 12 together, after the filter configuration parameters respectively corresponding to the hearing compensation parameter and the ear canal equalization parameter are determined and the corresponding first filter and second filter are configured, a frequency response obtained by the cascaded first filter and second filter is shown in FIG. 11, and the effect of performing transparent transmission compensation on the target audio signal received by the audio playback device using the first filter and the second filter is shown in FIG. 12. The dotted line in FIG. 12 may represent the system frequency response before the transparent transmission compensation is performed, and the solid line may represent the system frequency response after the transparent transmission compensation is performed. As can be seen, the transparent transmission compensation at the frequency point A in FIG. 11 is less, and the transparent transmission compensation effect near the frequency point A in FIG. 12 is not obvious; the transparent transmission compensation at the frequency point B in FIG. 11 is more, and the transparent transmission compensation effect near the frequency point B in FIG. 12 is more obvious.

As can be seen, with the audio signal processing method described in the above embodiments, the audio playback device can accurately determine the corresponding transparent transmission parameters based on the ear canal structure differences and hearing feature differences of different users, and perform personalized transparent transmission compensation on the external audio signals subsequently received by the audio playback device, so that the audio playback device can transparently transmit the external audio signals to the user as accurately as possible. This can effectively improve the accuracy of the transparent transmission processing performed on the external audio signals by the audio playback device, and be conducive to improving the user experience of using the audio playback device. In addition, by detecting the ambient sound of the environment in which the audio playback device is located, it helps to ensure the reliability of subsequent ear canal difference detection and hearing feature detection, which is beneficial to further improving the accuracy of the transparent transmission processing performed on the external audio signals by the audio playback device.

The methods in the embodiments of the present disclosure are described in detail above. The apparatus in the embodiments of the present disclosure is introduced below with reference to the accompanying drawings.

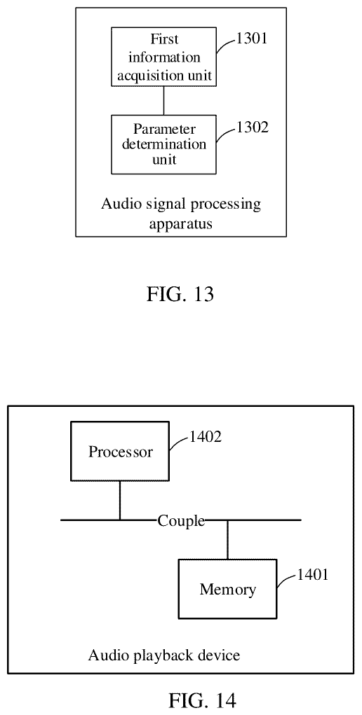

Referring to FIG. 13, a modular schematic diagram of an audio signal processing apparatus as disclosed in the embodiments of the present disclosure is shown. The audio signal processing apparatus may be the audio playback device involved in FIG. 1 to FIG. 12, or it may be an apparatus implemented in the audio playback device, which is not limited here. In the embodiments of the present disclosure, the audio playback device may include a first speaker, a feedforward microphone, and a feedback microphone. The audio playback device may also establish a communication connection with a terminal device, and the terminal device may include a second speaker. As illustrated in FIG. 13, the audio signal processing apparatus may include a first information acquisition unit 1301 and a parameter determination unit 1302.

The first information acquisition unit 1301 is configured to acquire hearing feature information for first detection audio signals, where the first detection audio signals are output by the terminal device that establishes the communication connection with the audio playback device.

The parameter determination unit 1302 is configured to determine a transparent transmission parameter based on the hearing feature information, and the transparent transmission parameter is configured to perform transparent transmission processing on a target audio signal to be received by the feedforward microphone.

As can be seen, with the audio signal processing apparatus described in the above embodiment, the audio playback device can accurately determine the corresponding transparent transmission parameters based on the differences in hearing features of different users, and perform personalized transparent transmission compensation on the external audio signals subsequently received by the audio playback device, so that the audio playback device can transparently transmit the external audio signals to the user as accurately as possible. Such an audio signal processing apparatus can effectively improve the accuracy of the transparent transmission processing performed on the external audio signals by the audio playback device, which provides different users with external audio signals that have undergone adaptive transparent transmission processing and match the user's hearing-related characteristics, and is beneficial to improving the user's experience of using the audio playback device.

In an embodiment, the audio signal processing apparatus may further include a second information acquisition unit (not shown), and the second information acquisition unit may be configured to:
acquire ear canal feature information calculated based on a first received audio signal, where the first received audio signal is collected by the feedback microphone and corresponds to a second detection audio signal, and the second detection audio signal is output by the audio playback device through the first speaker.

The parameter determination unit 1302 may be specifically configured to:
determine the transparent transmission parameter, based on the ear canal feature information and the hearing feature information.

In an embodiment, the audio signal processing apparatus may further include a first response unit and an instruction sending unit (not shown).

The first response unit is configured to disconnect an audio data transmission link with the terminal device in response to a hearing feature detection instruction, before the first information acquisition unit 1301 acquires the hearing feature information for the first detection audio signals.

The instruction sending unit is configured to send a detection trigger instruction to the terminal device, and the detection trigger instruction is configured to trigger the terminal device to play the first detection audio signals through its second speaker.

In an embodiment, the audio signal processing apparatus may further include a first audio receiving unit (not shown), and the first audio receiving unit may be configured to collect, through the feedforward microphone, a loudness calibration test signal played by the terminal device through the second speaker, before the instruction sending unit sends the detection trigger instruction to the terminal device.

The parameter determination unit 1302 may further be configured to determine loudness calibration parameters according to the loudness calibration test signal.

The instruction sending unit may be specifically configured to send the detection trigger instruction containing the loudness calibration parameters to the terminal device, and the detection trigger instruction is configured to trigger the terminal device to perform, according to the loudness calibration parameters, loudness compensation calibration on the first detection audio signals to be played, and play, through the second speaker, the first detection audio signals after undergoing the loudness compensation calibration.

As an optional implementation, regarding determining the loudness calibration parameters according to the loudness calibration test signal by the parameter determination unit 1302, the following operations may be specifically included:
separating, from the loudness calibration test signal, test sub-signals respectively at N test frequency points, where N is a positive integer greater than or equal to 1; and
determining the loudness calibration parameter corresponding to each of the N test frequency points, according to a signal strength of the test sub-signal and a respective reference strength.

The instruction sending unit may be specifically configured to send, to the terminal device, the detection trigger instruction containing the loudness calibration parameters respectively corresponding to the N test frequency points, and the detection trigger instruction is configured to trigger the terminal device to perform, according to the loudness calibration parameters respectively corresponding to the N test frequency points, loudness compensation calibration on the first detection audio signals respectively at the N test frequency points before being played, and play, through the second speaker, the first detection audio signals respectively at the N test frequency points after undergoing the loudness compensation calibration.

The first detection audio signals and the test sub-signals at the N test frequency points may all be pure tone signals.

On this basis, the first information acquisition unit 1301 may be specifically configured to:
acquire a hearing state fed back for a first detection audio signal at a first test frequency point, where the first test frequency point is any one of the N test frequency points;
adjusting, according to the hearing state, a first sound loudness of the first detection audio signal, to determine a sound loudness threshold corresponding to the first test frequency point, where the sound loudness threshold is a critical sound loudness at which the first detection audio signal is capable of being heard by the user; and
taking the sound loudness threshold as the hearing feature information fed back for the first detection audio signal at the first test frequency point.

As can be seen, with the audio signal processing apparatus described in the above embodiments, based on the ear canal difference detection and the hearing feature detection performed by the audio playback device and the terminal device, the detection process of the user's hearing-related characteristics can be conveniently and reliably implemented without the need for a special detection device, which effectively reduces the difficulty of configuring a personalized transparent transmission filter using the audio playback device, and improves the convenience of the audio playback device in performing transparent transmission processing on external audio signals.

In an embodiment, the transparent transmission parameter may include at least an ear canal equalization parameter and a hearing compensation parameter. Regarding determining the transparent transmission parameter according to the ear canal feature information and the hearing feature information by the parameter determination unit 1302, the following operations may be specifically included:
determining an ear canal equalization parameter according to the ear canal feature information, where the ear canal equalization parameter is configured to perform personalized ear canal equalization processing on the target audio signal to be received by the feedforward microphone; and
   determining a hearing compensation parameter according to the hearing feature information, and the hearing compensation parameter is configured to perform personalized hearing compensation processing on the target audio signal to be received by the feedforward microphone.

As an optional implementation, regarding acquiring the ear canal feature information calculated based on the first received audio signal by the second information acquisition unit, it may specifically include:
performing windowed segmentation on the first received audio signal according to a unit window length, to obtain at least one frame of received audio sub-signal;
determining, according to each frame of received audio sub-signal, an ear canal structure transfer function corresponding to the first received audio signal, where the ear canal feature information includes the ear canal structure transfer function.

On this basis, regarding determining the ear canal equalization parameter based on the ear canal feature information by the parameter determination unit 1302, it may specifically include:
determining, according to the ear canal structure transfer function and a reference transfer function, a corresponding ear canal equalization transfer function as the ear canal equalization parameter.

As an optional implementation manner, regarding determining the hearing compensation parameter based on the hearing feature information by the parameter determination unit 1302, it may specifically include:
fitting, according to the sound loudness thresholds respectively corresponding to the test frequency points, a corresponding hearing compensation transfer function as the hearing compensation parameter.

In an embodiment, the audio signal processing apparatus may further include a first configuration unit and a second configuration unit (not shown).

The first configuration unit is configured to configure a first filter according to the hearing compensation parameter, and configure a second filter according to the ear canal equalization parameter.

The second configuration unit is configured to cascade the first filter and second filter, where the first filter is used to perform personalized hearing compensation processing on the target audio signal to be received by the feedforward microphone, and the second filter is used to perform personalized ear canal equalization processing on the target audio signal after undergoing the personalized hearing compensation processing.

In an embodiment, the audio signal processing apparatus may further include a wear status detection unit (not shown), and the wear status detection unit may be configured to detect a device wear status of the audio playback device before the second information acquisition unit acquires the ear canal feature information calculated based on the first received audio signal.

Then, the first audio receiving unit may further be configured to collect a second received audio signal through the feedforward microphone when the device wear status is a wearing status.

The parameter determination unit 1302 may further be configured to determine a corresponding ambient sound parameter based on the second received audio signal, so that when the ambient sound parameter meets an audio transparent transmission processing condition, the second information acquisition unit may acquire the ear canal feature information calculated based on the first received audio signal.

As can be seen, with the audio signal processing apparatus described in the above embodiment, the audio playback device can accurately determine the corresponding transparent transmission parameters based on the ear canal structure differences and hearing feature differences of different users, and perform personalized transparent transmission compensation on the external audio signals subsequently received by the audio playback device, so that the audio playback device can transparently transmit the external audio signals to the user as accurately as possible. This can effectively improve the accuracy of the transparent transmission processing performed on the external audio signals by the audio playback device, and be conducive to improving the user experience of using the audio playback device. In addition, by detecting the ambient sound of the environment in which the audio playback device is located, it helps to ensure the reliability of subsequent ear canal difference detection and hearing feature detection, which is beneficial to further improving the accuracy of the transparent transmission processing performed on the external audio signals by the audio playback device.

Referring to FIG. 14, a modular schematic diagram of an audio playback device as disclosed in the embodiments of the present disclosure is shown. As illustrated in FIG. 14, the audio playback device may include: a memory 1401 storing executable program codes, and a processor 1402 coupled to the memory 1401.

The processor 1402 calls the executable program codes stored in the memory 1401 to execute all or part of the operations in any one of the audio signal processing methods described in the above embodiments.

In addition, the embodiments of the present disclosure further disclose a non-transitory computer-readable storage medium, which stores a computer program for electronic data exchange. The computer program enables a computer to execute all or part of the operations in any one of the audio signal processing methods described in the above embodiments.

In addition, the embodiments of the present disclosure further disclose a computer program product. When the computer program product is run on a computer, the computer is caused to execute all or part of the operations in any one of the audio signal processing methods described in the above embodiments.

Those of ordinary skill in the art will appreciate that all or part of the operations in the various methods of the above embodiments may be completed by instructing related hardware through a program, and the program may be stored in a computer-readable storage medium. The storage medium includes a read-only memory (ROM), a random access memory (RAM), a programmable read-only memory (PROM), an erasable programmable read-only memory (EPROM), a one-time programmable read-only memory (OTPROM), an electronically erasable programmable read-only memory (EEPROM), a compact disc read-only memory (CD-ROM) or other optical disc storage, magnetic disk storage, magnetic tape storage, or any other computer-readable medium that can be used to carry or store data.

The foregoing has introduced in detail the audio signal processing method and apparatus, the audio playback device, and the storage medium disclosed in the embodiments of the present disclosure. Specific examples are used in this disclosure to illustrate the principles and implementations of the present disclosure. The description of the above embodiments is only used to help understand the methods of the present disclosure and its core idea. In addition, one of ordinary skill in the art may make, according to the idea of the present disclosure, modifications in the specific implementations and application scopes. In summary, the content of the specification should not be understood as a limitation on the present disclosure.

What is claimed is:

1. An audio signal processing method, for an audio playback device, the audio playback device comprising a feedforward microphone, and the method comprising:
acquiring hearing feature information for first detection audio signals, wherein the first detection audio signals are output by a terminal device that establishes a communication connection with the audio playback device; and
determining a transparent transmission parameter based on the hearing feature information, wherein the transparent transmission parameter is configured to perform transparent transmission processing on a target audio signal received by the feedforward microphone.

2. The method as claimed in claim 1, wherein the audio playback device further comprises a first speaker and a feedback microphone, and the method further comprises:
acquiring ear canal feature information calculated based on a first received audio signal, wherein the first received audio signal is collected by the feedback microphone and corresponds to a second detection audio signal, and the second detection audio signal is output by the audio playback device through the first speaker; and
the determining the transparent transmission parameter based on the hearing feature information comprises:
determining the transparent transmission parameter, based on the ear canal feature information and the hearing feature information.

3. The method as claimed in claim 1, wherein the terminal device comprises a second speaker, and before acquiring the hearing feature information for the first detection audio signals, the method further comprises:
in response to a hearing feature detection instruction, disconnecting an audio data transmission link between the terminal device and the audio playback device; and
sending a detection trigger instruction to the terminal device, wherein the detection trigger instruction is configured to trigger the terminal device to play the first detection audio signals through the second speaker.

4. The method as claimed in claim 3, wherein before sending the detection trigger instruction to the terminal device, the method further comprises:
collecting, through the feedforward microphone, a loudness calibration test signal played by the terminal device through the second speaker; and
determining loudness calibration parameters based on the loudness calibration test signal; and
the sending the detection trigger instruction to the terminal device comprises:
sending, to the terminal device, the detection trigger instruction containing the loudness calibration parameters, wherein the detection trigger instruction is configured to trigger the terminal device to perform, according to the loudness calibration parameters, loudness compensation calibration on the first detection audio signals before being played, and play, through the second speaker, the first detection audio signals after undergoing the loudness compensation calibration.

5. The method as claimed in claim 4, wherein the determining the loudness calibration parameters based on the loudness calibration test signal, comprises:
separating, from the loudness calibration test signal, test sub-signals respectively at N test frequency points, where N is a positive integer greater than or equal to 1; and
determining the loudness calibration parameter corresponding to each of the N test frequency points, based on a signal strength of the test sub-signal and a respective reference strength; and
the sending, to the terminal device, the detection trigger instruction containing the loudness calibration parameters comprises:
sending, to the terminal device, the detection trigger instruction containing the loudness calibration parameters respectively corresponding to the N test frequency points, wherein the detection trigger instruction is configured to trigger the terminal device to perform, according to the loudness calibration parameters respectively corresponding to the N test frequency points, loudness compensation calibration on the first detection audio signals respectively at the N test frequency points before being played, and play, through the second speaker, the first detection audio signals respectively at the N test frequency points after undergoing the loudness compensation calibration.

6. The method as claimed in claim 5, wherein the first detection audio signals and the test sub-signals at the N test frequency points are all pure tone signals.

7. The method as claimed in claim 5, wherein the acquiring the hearing feature information for the first detection audio signals comprises:
acquiring an hearing state fed back for one of the first detection audio signals that is at a first test frequency point, wherein the first test frequency point is any one of the N test frequency points;
adjusting a first sound loudness of the one first detection audio signal according to the hearing state, and determining a sound loudness threshold corresponding to the first test frequency point through the adjustment, wherein the sound loudness threshold is a critical sound loudness at which the one first detection audio signal is capable of being heard by a user; and
taking the sound loudness threshold as the hearing feature information fed back for the one first detection audio signal at the first test frequency point.

8. The method as claimed in claim 2, wherein the transparent transmission parameter comprises at least an ear canal equalization parameter and a hearing compensation parameter, and the determining the transparent transmission parameter based on the ear canal feature information and the hearing feature information comprises:
determining the ear canal equalization parameter based on the ear canal feature information, wherein the ear canal equalization parameter is configured to perform personalized ear canal equalization processing on the target audio signal received by the feedforward microphone; and
determining the hearing compensation parameter based on the hearing feature information, wherein the hearing compensation parameter is configured to perform personalized hearing compensation processing on the target audio signal received by the feedforward microphone.

9. The method as claimed in claim 8, wherein the acquiring the ear canal feature information calculated based on the first received audio signal comprises:
performing windowed segmentation on the first received audio signal according to a unit window length, and obtaining at least one frame of received audio sub-signal through the windowed segmentation; and
determining, according to the at least one frame of received audio sub-signal, an ear canal structure transfer function corresponding to the first received audio signal, wherein the ear canal feature information comprises the ear canal structure transfer function; and
the determining the ear canal equalization parameter based on the ear canal feature information comprises:
determining, according to the ear canal structure transfer function and a reference transfer function, a corresponding ear canal equalization transfer function as the ear canal equalization parameter.

10. The method as claimed in claim 8, wherein the determining the hearing compensation parameter based on the hearing feature information comprises:
fitting, based on sound loudness thresholds respectively corresponding to N test frequency points, a corresponding hearing compensation transfer function as the hearing compensation parameter.

11. The method as claimed in claim 8, wherein the method further comprises:
configuring a first filter according to the hearing compensation parameter, and configuring a second filter according to the ear canal equalization parameter; and
cascading the first filter and the second filter, wherein the first filter is configured to perform personalized hearing compensation processing on the target audio signal received by the feedforward microphone, and the second filter is configured to perform personalized ear canal equalization processing on the target audio signal after undergoing the personalized hearing compensation processing.

12. The method as claimed in claim 1, wherein before acquiring the hearing feature information for the first detection audio signals, the method further comprises:
detecting a device wear status of the audio playback device;
in response to the device wear status being a wearing status, collecting a second received audio signal through the feedforward microphone; and
determining, based on the second received audio signal, a corresponding ambient sound parameter, and in response to the ambient sound parameter meeting an audio transparent transmission processing condition, performing the operation of acquiring the hearing feature information for the first detection audio signals.

13. An audio playback device, comprising a memory, a processor, and a feedforward microphone, wherein the memory stores therein a computer program which, when being executed by the processor, causes the processor to:
acquire hearing feature information for first detection audio signals, wherein the first detection audio signals are output by a terminal device that establishes a communication connection with the audio playback device; and
determine a transparent transmission parameter based on the hearing feature information, wherein the transparent transmission parameter is configured to perform transparent transmission processing on a target audio signal received by the feedforward microphone.

14. The audio playback device as claimed in claim 13, wherein the audio playback device further comprises a first speaker and a feedback microphone, the processor is further caused to:
acquire ear canal feature information calculated based on a first received audio signal, wherein the first received audio signal is collected by the feedback microphone while a second detection audio signal is output by the audio playback device through the first speaker; and
determine the transparent transmission parameter, based on the ear canal feature information and the hearing feature information.

15. The audio playback device as claimed in claim 13, wherein the terminal device comprises a second speaker, and before the hearing feature information for the first detection audio signals is acquired, the processor is further caused to:
in response to a hearing feature detection instruction, disconnect an audio data transmission link between the terminal device and the audio playback device; and
send a detection trigger instruction to the terminal device, wherein the detection trigger instruction is configured to trigger the terminal device to play the first detection audio signals through the second speaker.

16. The audio playback device as claimed in claim 15, wherein the processor is further caused to:
collect, through the feedforward microphone, a loudness calibration test signal played by the terminal device through the second speaker;
separate, from the loudness calibration test signal, test sub-signals respectively at N test frequency points, where N is a positive integer greater than or equal to 1;
determine a loudness calibration parameter corresponding to each of the N test frequency points, based on a signal strength of the test sub-signal and a respective reference strength; and
send, to the terminal device, the detection trigger instruction containing the loudness calibration parameters respectively corresponding to the N test frequency points, wherein the detection trigger instruction is configured to trigger the terminal device to perform, according to the loudness calibration parameters respectively corresponding to the N test frequency points, loudness compensation calibration on the first detection audio signals respectively at the N test frequency points, and play, through the second speaker, the first detection audio signals respectively at the N test frequency points after undergoing the loudness compensation calibration;
wherein the first detection audio signals and the test sub-signals at the N test frequency points are all pure tone signals.

17. The audio playback device as claimed in claim 16, wherein the processor is further caused to:
acquire an hearing state fed back for one of the first detection audio signals that is at a first test frequency point, wherein the first test frequency point is any one of the N test frequency points;
adjust a first sound loudness of the one first detection audio signal according to the hearing state, and determine a sound loudness threshold corresponding to the first test frequency point through the adjustment, wherein the sound loudness threshold is a critical sound loudness at which the one first detection audio signal is capable of being heard by a user; and
take the sound loudness threshold as the hearing feature information fed back for the one first detection audio signal at the first test frequency point.

18. The audio playback device as claimed in claim 14, wherein the transparent transmission parameter comprises at least an ear canal equalization parameter and a hearing compensation parameter, the audio playback device further comprises a first filter and a second filter, and the processor is further configured to:
determine the ear canal equalization parameter based on the ear canal feature information, and determine the hearing compensation parameter based on the hearing feature information; and
configure the first filter according to the hearing compensation parameter, and configure the second filter according to the ear canal equalization parameter;
wherein the first filter and the second filter are cascaded, the first filter is configured to perform personalized hearing compensation processing on the target audio signal received by the feedforward microphone, and the second filter is configured to perform personalized ear canal equalization processing on the target audio signal after undergoing the personalized hearing compensation processing.

19. The audio playback device as claimed in claim 18, wherein the processor is further configured to:
perform windowed segmentation on the first received audio signal according to a unit window length, and obtain at least one frame of received audio sub-signal through the windowed segmentation;
determine, according to the at least one frame of received audio sub-signal, an ear canal structure transfer function corresponding to the first received audio signal, wherein the ear canal feature information comprises the ear canal structure transfer function; and
determine, according to the ear canal structure transfer function and a reference transfer function, a corresponding ear canal equalization transfer function as the ear canal equalization parameter; and
the processor is further configured to: fit, based on sound loudness thresholds respectively corresponding to N test frequency points, a corresponding hearing compensation transfer function as the hearing compensation parameter.

20. A non-transitory computer-readable storage medium having a computer program stored thereon, wherein the computer program, when being executed by a processor of an audio playback device, causes the processor to:
acquire hearing feature information for first detection audio signals, wherein the first detection audio signals are output by a terminal device that establishes a communication connection with the audio playback device; and
determine a transparent transmission parameter based on the hearing feature information, wherein the transparent transmission parameter is configured to perform transparent transmission processing on a target audio signal received by a feedforward microphone of the audio playback device.
